(19) United States
(12) Patent Application Publication
(10) Pub. No.: US 2013/0316667 A1
(43) Pub. Date: Nov. 28, 2013

(54) RF SIGNAL CHOKING DEVICE AND ANTENNA SYSTEM WITH A RF SIGNAL CHOKING DEVICE

(71) Applicant: MOBI ANTENNA TECHNOLOGIES (SHENZHEN) CO., LTD., Nanshan District (CN)

(72) Inventors: Min Zhang, Nanshan District (CN); Bingbing Yao, Nanshan District (CN); Yaqin Yan, Nanshan District (CN)

(73) Assignee: MOBI ANTENNA TECHNOLOGIES (SHENZHEN) CO., LTD., Nanshan District (CN)

(21) Appl. No.: 13/900,733

(22) Filed: May 23, 2013

(30) Foreign Application Priority Data
May 24, 2012 (CN) 201210163435.9

(51) Int. Cl. H04B 1/04

(52) U.S. Cl. CPC H04B 1/0475
USPC 455/114.2

(57) ABSTRACT

A RF signal choking device includes: a first port electrically receiving direct current, RF signals, and antenna interface standards group (AISG) signals from a base station; a blocking capacitor being provided for blocking the direct current and the AISG signal and transmitting the RF signal; a second port connected to the other end of the blocking capacitor, for outputting the RF signal; a first inductor, one end of which is connected to the first port, for transmitting the AISG signal and the direct current; a modulator, one end of which is connected to the other end of the first inductor, for processing the AISG signal; a third port, which is connected to the other end of the modulator, for outputting the processed AISG signal; and a second inductor, one end of which is connected to the second port and the other end of which is connected to the ground.

### TECHNICAL FIELD

The present invention relates to communication field, and more particularly, to a RF signal choking device and a system with a RF signal choking device.

### BACKGROUND

In a communication system, the multi-frequency and wide band antenna is widely used with the development of the communication technology. A bias-T head is a RF choke device for feeding for tower mounted amplifier (TMA) or antenna systems. Referring to FIG. 1, general hollow coil inductors are used as a choke inductor of RF choke device sold in the present market. However, the hollow coil inductors has a low Q value, large distributed capacitance, narrow work band, and only can work in the range of 800 MHz-2 GHz. With the development of the Long Term Evolution (LTE) technology, the devices work in the range of 700 MHz-2600 MHz are more popular, and the bands of the antennas are more wider, therefore the multi-frequency RF signal choking device are required to be used together, thereby, the run cost of the communication system is increased. Further, the isolation in the antenna interface standards group (AISG) is not enough, thereby resulting in interference between the AISG signal and the RF signals of the communication system.

### SUMMARY

A technical problem to be solved by the present invention is to provide an improved a RF signal choking device to compensate for the defects of the existing technology.

Another technical problem to be solved by the present invention is to provide an improved antenna system with the RF signal choking device.

The above-mentioned technical problems can be solved through the following technical solutions.

A RF signal choking device includes: a first port electrically connected to a base station, being provide for receiving direct current, RF signals, and antenna interface standards group (AISG) signals from the base station; a blocking capacitor, one end of which is connected to the first port, being provided for blocking the direct current and the AISG signal and transmitting the RF signal; a second port connected to the other end of the blocking capacitor, being provided for outputting the RF signal; a first inductor, one end of which is connected to the first port, being provided for transmitting the AISG signal and the direct current; a modulator, one end of which is connected to the other end of the first inductor, being provided for processing the AISG signal; a third port, which is connected to the other end of the modulator, being provided for outputting the processed AISG signal; and a second inductor, one end of which is connected to the second port and the other end of which is connected to the ground.

Preferably, the first inductor and the second inductor of the above RF signal choking device both are a taper hollow winding inductor.

Preferably, the angle of the taper hollow winding inductor of the RF signal choking device is from 5° to 25°.

The antenna system with the RF signal choking device as described above includes a first port electrically connected to a base station, being provide for receiving direct current, RF signals, and antenna interface standards group (AISG) signals from the base station; a blocking capacitor, one end of which is connected to the first port, being provided for blocking the direct current and the AISG signal and transmitting the RF signal; a second port connected to the other end of the blocking capacitor, being provided for outputting the RF signal; a first inductor, one end of which is connected to the first port, being provided for transmitting the AISG signal and the direct current; a modulator, one end of which is connected to the other end of the first inductor, being provided for processing the AISG signal; a third port, which is connected to the other end of the modulator, being provided for outputting the processed AISG signal; and a second inductor, one end of which is connected to the second port and the other end of which is connected to the ground.

### BRIEF DESCRIPTION OF THE DRAWINGS

FIG. 1 is a schematic view of a RF choke device of a related art;

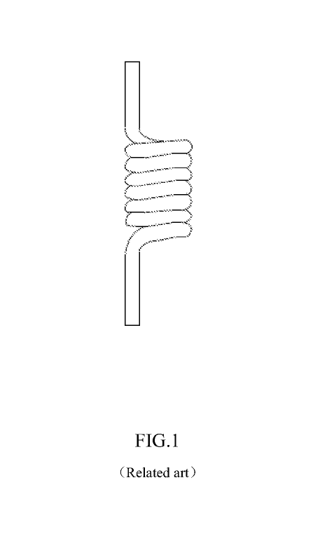

FIG. 2 is a schematic view of a structure of a RF choke device in accordance with an embodiment.

FIG. 3 is a schematic view of a taper hollow winding inductor of the RF choke device of FIG. 2.

FIG. 4 is an assembly diagram of the RF choke device of FIG. 1

### DETAILED DESCRIPTION OF THE PREFERRED EMBODIMENTS

Embodiments of the present invention will be explained below in detail with reference to the accompanying drawings.

The object of the present invention is for providing a RF signal choking device for widening work band of the PF choke device and therefore improving the insulator between the RF signal choking device and the AISG signal.

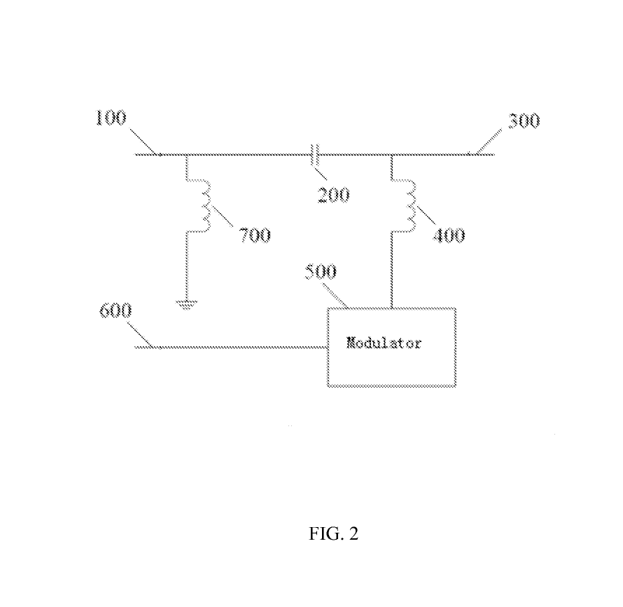

FIG. 2 shows a schematic diagram of structures of a RF signal choking device in accordance with an embodiment. For easy description, only parts related to the present invention are shown.

In the embodiment, the RF signal choking device includes a first port 300, a second port 100, a third port 600, a blocking capacitor 200, a first inductor 400, a second inductor 700, and a modulator 500.

The first port 300 is electrically connected to a base station (not shown) and provided for receiving direct current, RF signals, and antenna interface standards group (AISG) signals from the base station. The received direct signal provides power for the RF signal choking device.

The blocking capacitor 200, one end of which is connected to the first port 300, is provided for blocking the direct current and the AISG signal and transmitting the RF signal.

The second port 100 connected to the other end of the blocking capacitor 200, is provided for outputting the RF signal.

The first inductor 400, one end of which is connected to the first port 300, is provided for blocking the RF signal and transmitting the AISG signals and the direct current.

The modulator 500, one end of which is connected to the other end of the first inductor 400, being provided for processing the AISG signals.

The third port 600, which is connected to the other end of the modulator 500, is provided for outputting the processed AISG signals.

The second inductor 700, one end of which is connected to the second port 100 and the other end of which is connected to the ground to widen the band of the RF signal choking device and improve the insulator between the RF signal choking device and the AISG signal. Additionally, the feedback AISG signals is inputted to the third port 600 and outputted from the second port 300. Because the insulator of the coupling signal between the second port 300 and the first port 100 is at least 30 db, therefore, the coupling signal can not interfere the AISG signal.

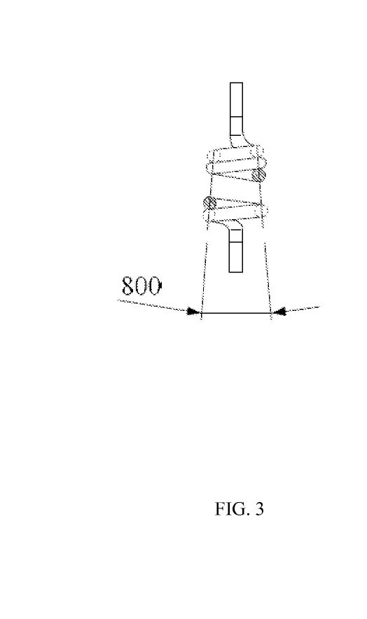

FIG. 3 shows structure diagram of a taper hollow winding inductor in accordance with an embodiment. For easy description, only the parts related to the present invention are shown.

According to the embodiment, the first inductor 400 and the second inductor 700 are a taper hollow winding inductor.

In the present embodiment, due to characters of high Q value, small distributed capacitance, RF blocking, allowing DC to pass, and insulating power and the active device, the taper hollow winding inductor greatly widens the band of the RF choke device. Thereby, the RF choke device with widening band can be widely used in frequency bands of GSM, CDMA, WCDMA, and TD-SCDMA to satisfy the actual application requirements and decrease the application costs.

In the present embodiment, the range of the angle 800 of the taper hollow winding inductor is from 5° to 25°. Experiments indicate that the band of the RF choke device can be most effectively widened when the angle 800 of the taper hollow winding inductor is in the range of 5°˜25°.

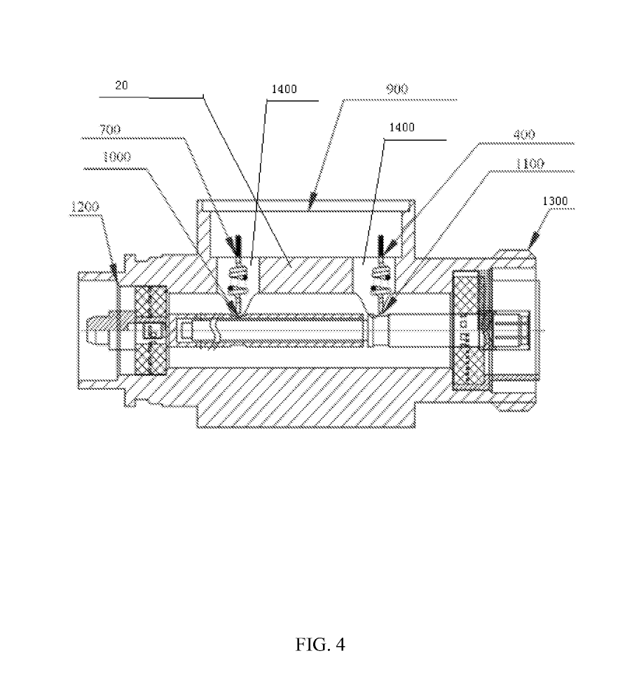

FIG. 4 shows an assembly structure of the RF choke device in accordance with an embodiment. The assembly structure of the RF choke device includes a first taper hollow winding inductor 400 (hereinafter the “first taper inductor”), a second taper hollow winding inductor 700 (hereinafter the “second taper inductor”), a first port connector 1200, a second port connector 1300, a first assembly position 1000 for assembling the second taper inductor 700, and a second assembly position 1100 for assembling the first taper inductor 400.

The first port connector 1200 and the second port connector 1300 of the RF signal choking device manufactured with the housing 900 are respectively provided for connecting the first port 100 and the second port 300. A thick end of the first taper inductor 400 is assembled to the first assembly position 1000 to make the first taper inductor 400 connect to the first port 100. A thick end of the second taper inductor 700 is assembled to the second assembly position 1100 to make the second taper inductor 700 connect to the second port 300 A thin end of the first taper inductor 400 and a thin end of the second taper inductor 700 are respectively inserted through two holes 1400 of a PCB 20 and are further fixed on the housing 900 of the RF signal choking device.

In the present embodiment, the RF signal choking device is easy to assemble, and thus to save the assembling time and improve the manufacture speed of the RF signal choking device.

Another object of the present invention is for providing an antenna system with the above RF signal choking device. The antenna system with the RF signal choking device includes a first port 300, a second port 100, a third port 600, a blocking capacitor 200, a first inductor 400, and a second inductor 700.

The first port 300 is electrically connected to a base station and provided for receiving direct current, RF signals, and antenna interface standards group (AISG) signals from the base station. The received direct signal provides power for the RF signal choking device.

The blocking capacitor 200, one end of which is connected to the first port 300, is provided for blocking the direct current and the AISG signal and transmitting the RF signal.

The second port 100 connected to the other end of the blocking capacitor 200, is provided for outputting the RF signal.

The first inductor 400, one end of which is connected to the first port 300, being provided for blocking the RF signal and transmitting the AISG signals and the direct current.

The modulator 500, one end of which is connected to the other end of the first inductor 400, being provided for processing the AISG signals.

The third port 600, which is connected to the other end of the modulator 500, is provided for outputting the processed AISG signals.

The second inductor 700, one end of which is connected to the second port 100 and the other end of which is connected to the ground to widen the band of the RF signal choking device.

In the present invention, the assembled RF stoke device is connected to a test device to test. The test results show that the insertion loss and standing-wave ratio of the RF signal choking device of the present invention satisfy the requirements of current industry standard, and the work band of the RF signal choking device of the present invention is wider 50% than the current RF signal choking device that are not improved, and when the RF stoke device of the present invention is used in the communication system, the insulator of the AISG signal is higher more than two times than the communication system without using the improved RF signal choking device of the present invention. The test results further show that the RF signal choking device has fine performance when the environment temperature is in the range of −40° C.˜+80° C. and can satisfy the industry standard.

The present invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. A RF signal choking device comprising:
a first port electrically connected to a base station, and being provided for receiving direct current, RF signals, and antenna interface standards group (AISG) signals from the base station;
a blocking capacitor, one end of the blocking capacitor connected to the first port, being provided for blocking the direct current and the AISG signal and transmitting the RF signal;
a second port connected to the other end of the blocking capacitor, and being provided for outputting the RF signal;
a first inductor, one end of the first inductor connected to the first port, and being provided for transmitting the AISG signal and the direct current;
a modulator being provided for processing the AISG signal, one end of the modulator connected to the other end of the first inductor;
a third port, connected to the other end of the modulator, and being provided for outputting the processed AISG signal; and
a second inductor, one end of the second inductor connected to the second port and the other end of the second inductor connected to the ground.

2. The RF signal choking device as claimed in claim 1, wherein the first inductor and the second inductor both are a taper hollow winding inductor.

3. The RF signal choking device as claimed in claim 2, wherein the range of the angle of the taper hollow winding inductor is from 5° to 25°.

4. An antenna system with a RF signal choking device as claimed in claim 1, comprising:
a first port electrically connected to a base station, and being provide for receiving direct current, RF signals, and antenna interface standards group (AISG) signals from the base station;
a blocking capacitor being provided for blocking the direct current and the AISG signal and transmitting the RF signal, one end of the blocking capacitor connected to the first port;
a second port connected to the other end of the blocking capacitor for outputting the RF signal;
a first inductor being provided for transmitting the AISG signal and the direct current, one end of the first inductor connected to the blocking capacitor;
a modulator being provided for processing the AISG signal, one end of the modulator connected to the other end of the first inductor;
a third port connected to the other end of the modulator, and being provided for outputting the processed AISG signal; and
a second inductor, one end of the second inductor connected to the second port and the other end of the second inductor connected to the ground.
